(19) United States
(12) Patent Application Publication
(10) Pub. No.: US 2014/0205337 A1
(43) Pub. Date: Jul. 24, 2014

(54) IMAGE FORMING APPARATUS, SUB-DROPLET SUPPLYING UNIT, AND IMAGE FORMING METHOD

(71) Applicant: CANON KABUSHIKI KAISHA, Tokyo (JP)

(72) Inventor: Yasuharu Notoya, Tokyo (JP)

(73) Assignee: CANON KABUSHIKI KAISHA, Tokyo (JP)

(21) Appl. No.: 14/156,513

(22) Filed: Jan. 16, 2014

(30) Foreign Application Priority Data
Jan. 22, 2013 (JP) 2013-008981

(51) Int. Cl. G03G 15/20

(52) U.S. Cl. CPC G03G 15/2096
USPC 399/340

(57) ABSTRACT

A fixing solution injecting portion is configured to inject a fixing solution containing a water-soluble polymer and water pulsewise out of micropores to produce sub-droplets of the fixing solution smaller than main droplets of the fixing solution in producing the main droplets. A sub-droplet supplying portion is configured to separate the main droplets and the sub-droplets of the fixing solution injected out of the fixing solution injecting portion and to supply the sub-droplets to a toner image on an image carrier.

### BACKGROUND OF THE INVENTION

1. Field of the Invention

The present invention relates to an image forming apparatus configured to fix a toner image by using a fixing solution containing a water-soluble polymer and water.

2. Description of the Related Art

An image forming apparatus of a type configured to fix an image on a recording medium by heating and pressing the recording medium on which a toner image has been transferred by a fixing apparatus is now widely used. In such an image forming apparatus, a large part of power consumption is consumed for heating in the fixing apparatus. Due to that, there is proposed a so-called wet fixing type image forming apparatus that is configured to fix a toner image on a recording medium by using a fixing solution, containing a water-soluble polymer and water, without requiring heating. The wet fixing type image forming apparatus is configured to fix a toner image on a recording medium without crushing toner particles of the toner image but by evaporating moisture after permeating water-soluble polymer between gaps of the toner particles and between the toner particles and the recording medium.

For instance, Japanese Patent Application Laid-open No. 2001-188426 discloses an image forming apparatus using an aqueous solution of an ultraviolet hardening resin as a fixing solution and configured to supply particles of the fixing solution to a toner image on a recording medium by using an inkjet printing nozzle and then to irradiate an ultraviolet ray to the toner image on the recording medium on which the fixing solution has been permeated to fix an image on the recording medium.

Japanese Patent Application Laid-open No. 2004-109751 discloses an image forming apparatus configured to inject a water-soluble fixing solution that dissolves or softens and swells toner particles on a toner image on an image carrier, e.g., a photoconductor, an intermediate transfer body, and a recording medium, by using inkjet nozzles. The inkjet nozzles are arrayed with a fine pitch across a full conveyance width of the recording medium, and the recording medium is conveyed to intersect a jet direction of the inkjet nozzles.

Japanese Patent Application Laid-open No. 2008-276037 discloses an image forming apparatus configured to pass a recording medium on which a toner image has been transferred through a spray chamber of a water-soluble fixing solution that dissolves or softens and swells toner particles to cause particulates in the sprayed fixing solution be absorbed and permeated in the toner image. JPA No. 2008-276037 also describes that the particulates of the sprayed fixing solution should be 15 μm or less in diameter in order not to disturb the toner image or not to cause fixing irregularity.

As disclosed in JPA No. 2008-276037, it is necessary to increase density of the water-soluble polymer and to reduce water in order to avoid undulation of the recording medium in using the fixing solution containing the water-soluble polymer and water. However, viscosity of the fixing solution increases if the density of the water-soluble polymer is increased and water is reduced, and it becomes difficult to control the particulates (main droplet) of the fixing solution to be produced under 15 μm in diameter either in the spray method or the inkjet method.

It becomes necessary to increase an aperture of the nozzle in response to the increase of viscosity resistance in injecting a highly viscous liquid by using the inkjet nozzle in particular. Due to that, with the increase of the viscosity of the liquid to be injected, the liquid particle (main droplet) exceeds at least 20 μm in diameter when a columnar liquid injected pulsewise from the aperture is formed into a globular shape (main droplet) after the injection due to surface tension. Toner particles presently used to form a toner image are 5 to 7 μm in diameter, so that there is a possibility that a toner image is disturbed if liquid particles exceeding 20 μm in diameter impact a recording medium at high speed as toners around the collided liquid particle scatter.

### SUMMARY OF THE INVENTION

According to an aspect of the present invention, an image forming apparatus includes a toner image forming portion configured to form a toner image, an image carrier configured to carry the toner image formed by the toner image forming portion, a fixing solution injecting portion disposed in proximity with the image carrier and configured to have micropores to inject a fixing solution, containing a water-soluble polymer and water, pulsewise for filling up gaps between toner particles and fixing the toner image, the fixing solution injecting portion producing sub-droplets of the fixing solution whose size is smaller than that of main droplets in producing the main droplets by injecting the fixing solution out of the micropores, and a sub-droplet supplying portion configured to supply the sub-droplets to the toner image on the image carrier by separating the main droplets from the fixing solution injected out of the micropores.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus according a first embodiment of the invention.

FIG. 2 is a schematic diagram illustrating a configuration of an image forming portion of the first embodiment.

FIG. 3A is a schematic diagram illustrating a fixing process in the first embodiment.

FIG. 3B is a schematic diagram illustrating a next step in the fixing process in the first embodiment.

FIG. 3C is a schematic diagram illustrating a further step in the fixing process in the first embodiment.

FIG. 4A is a schematic diagram illustrating a disposition of a fixing solution supplying unit.

FIG. 4B is a schematic diagram illustrating a configuration of the fixing solution supplying unit.

FIG. 5 is a schematic diagram illustrating a configuration of a fixing solution injecting portion.

FIG. 6 is a perspective view schematically illustrating a disposition of a jet head.

FIG. 7 is a schematic diagram illustrating a configuration of a main droplet recovering portion.

FIG. 8 is a graph explaining a relationship between injection velocity and a reaching distance of a liquid droplet particle of the fixing solution.

FIG. 9 is a control block diagram of the fixing solution supplying unit.

FIG. 10 is a control flowchart of the fixing solution supplying unit.

FIG. 11 is a graph explaining a relationship between injection frequency of the jet head and a produced quantity of sub-droplets.

FIG. 12 is a graph explaining a relationship between driving intervals of adjacent micropores and a number of produced sub-droplets.

FIG. 13 is a schematic diagram illustrating a disposition of the fixing solution supplying unit in a first modified example.

FIG. 14 is a schematic diagram illustrating a move of the jet head in a second modified example.

FIG. 15 is a schematic diagram explaining electrification of the sub-droplet in a third modified example.

FIG. 16 is a schematic diagram illustrating a configuration of an image forming apparatus of a second embodiment.

### DESCRIPTION OF THE EMBODIMENTS

Embodiments of the present invention will be explained in detail below with reference to the drawings.

### First Embodiment

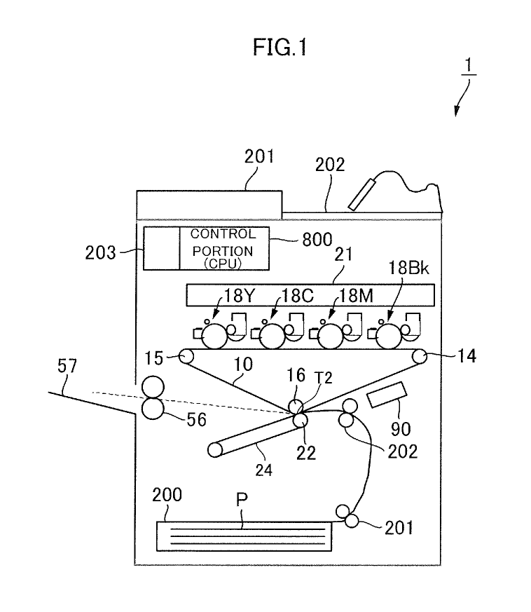

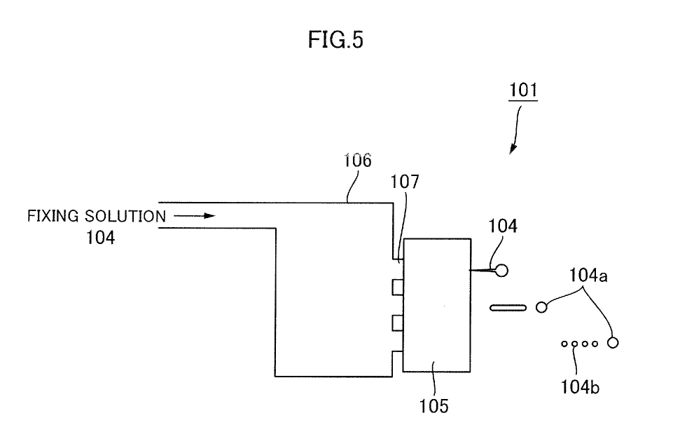

As shown in FIG. 1, an image forming apparatus of the embodiment includes an image forming portion 18Y, i.e., one exemplary toner image forming portion, configured to form and transfer a toner image to an intermediate transfer belt 10, i.e., one exemplary image carrier. As shown also in FIG. 5, a fixing solution injecting portion 101, i.e., one exemplary fixing solution injecting portion, is disposed in proximity with the intermediate transfer belt 10 and configured to inject a fixing solution, containing a water-soluble polymer and water, that fills up gaps between toner particles and fixes the toner image on a recording medium pulsewise out of micropores. The fixing solution injecting portion 101 produces sub-droplets of the fixing solution which are smaller than main droplets in producing the main droplets of the fixing solution. A quantity of the water contained in the fixing solution and supplied per unit area is less than 15 g/m². The water-soluble polymer is urethane resin.

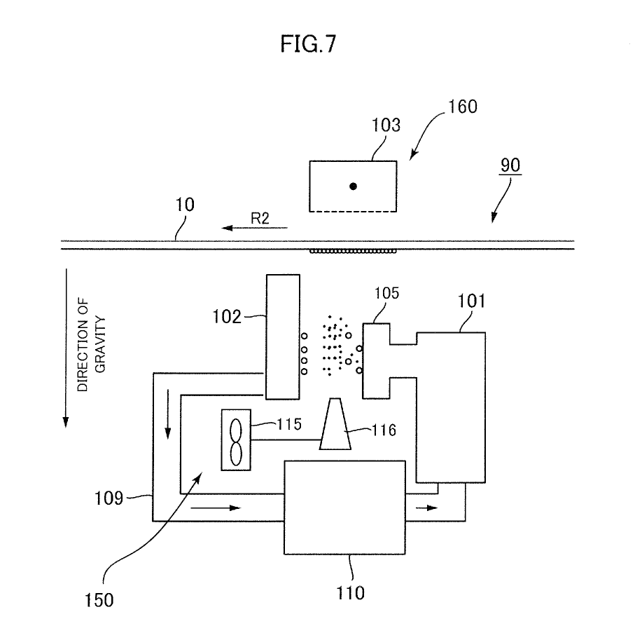

As shown in FIG. 7, a main droplet recovering portion 102, i.e., one exemplary sub-droplet supplying portion, is disposed to face the fixing solution injecting portion 101 and is configured to separate main droplets from the fixing solution injected out of the fixing solution injecting portion 101 and to output sub-droplets to outside to supply to the toner image on the intermediate transfer belt 10. A distance between the fixing solution injecting portion 101 and the main droplet recovering portion 102 facing to each other is set in accordance to a diameter of the sub-droplets to be supplied to the toner image on the intermediate transfer belt 10. The main droplet recovering portion 102 also separates large sub-droplets which are likely to disturb the toner image from the fixing solution injected out of the fixing solution injecting portion 101, and supplies small sub-droplets which are less likely to disturb the toner image to the toner image on the intermediate transfer belt 10.

An electric filed applying unit 103 which is one exemplary electric field forming portion is configured to form an electric field between the main droplet recovering portion 102 and the intermediate transfer belt 10 to electrically bias the sub-droplets discharged out of the fixing solution injecting portion 101 toward the intermediate transfer belt 10. A fan 115 which is one exemplary airflow forming portion is configured to form an airflow between the main droplet recovering portion 102 and the intermediate transfer belt 10 to blow the sub-droplets discharged out of the fixing solution injecting portion 101 toward the intermediate transfer belt 10. These electric field applying unit 103 and the fan 115 compose a guide portion 160 that moves the sub-droplets between the fixing solution injecting portion 101 and the main droplet recovering portion 102 toward the intermediate transfer belt 10. The guide portion 160 and the main droplet recovering portion 102 also compose the sub-droplet supply portion 150 that supplies the sub-droplets to the toner image on the intermediate transfer body (image carrier) 10.

The main droplet recovering portion 102 which is one exemplary recovery member receives and recovers at least the main droplets injected out of the fixing solution injecting portion 101. A supply pump 110 which is one exemplary recycling portion recycles the fixing solution of at least the main droplets recovered by the main droplet recovering portion 102 to the fixing solution injecting portion 101.

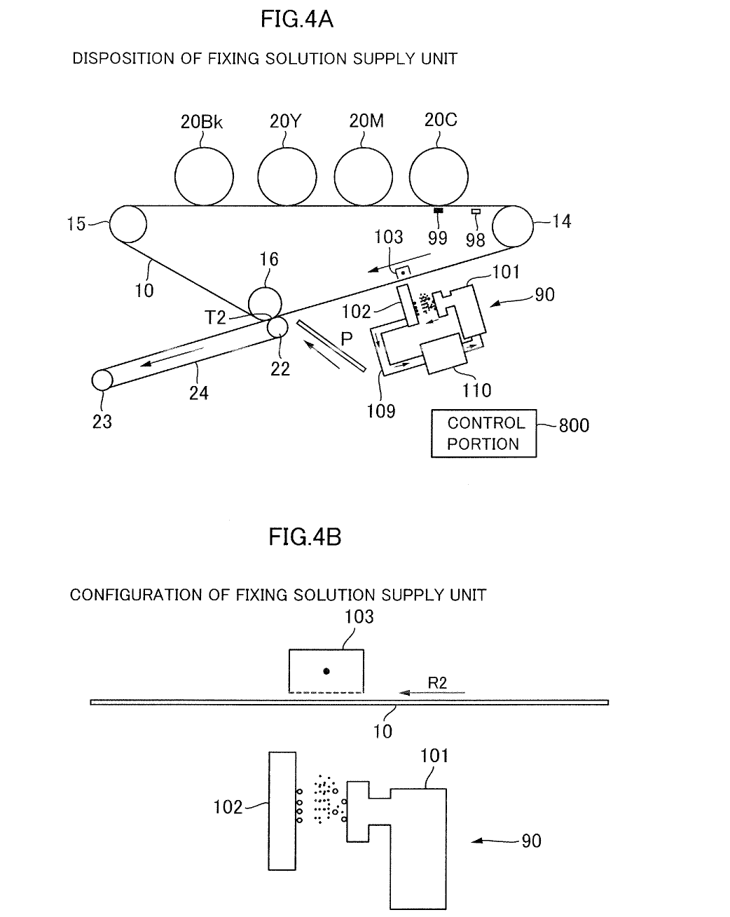

As shown in FIG. 4A, a secondary transfer outer roller 22 which is one exemplary pressure portion presses the toner image on the intermediate transfer belt 10 on which the fixing solution of the sub-droplets is supplied by the fixing solution injecting portion 101 at temperature and pressure not crashing the toner particles.

### (Image Forming Apparatus)

Specifically, FIG. 1 is a schematic diagram illustrating a configuration of the image forming apparatus 1 of the first embodiment. As shown in FIG. 1, the image forming apparatus 1 is a tandem intermediary transfer type full-color printer in which image forming portions 18Y, 18C, 18M and 18Bk of yellow cyan, magenta, and black are arrayed along the intermediate transfer belt 10.

The image forming portion 18Y is configured to form a yellow toner image and to transfer the toner image to the intermediate transfer belt 10. The image forming portion 18C is configured to form a cyan toner image and to transfer the toner image to the intermediate transfer belt 10. The image forming portions 18M and 18Bk are configured to form magenta and black toner images and to transfer the toner images to the intermediate transfer belt 10, respectively.

The four color toner images transferred to and superimposed on the intermediate transfer belt 10 are conveyed to a secondary transfer portion T2 after being conveyed to a fixing solution supplying unit 90 to be supplied with the fixing solution. In the secondary transfer portion T2, the toner image on the intermediate transfer belt 10 is laid on and pressed to a recording medium taken out of a recording medium cassette 200 one by one and sent out by a registration roller 202. Thereby, an image is fixed on the recording medium P. After that, the recording medium P is conveyed to a discharge roller 56 while being adsorbed to a transfer belt 24 and is discharged to a discharge tray 57.

### (Image Forming Portion)

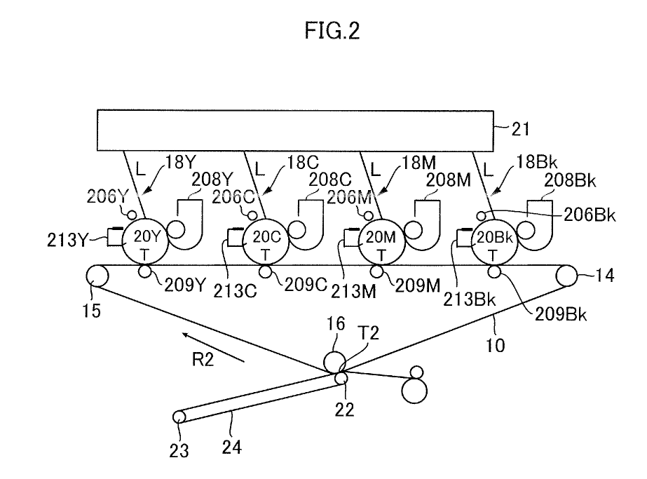

FIG. 2 is a schematic diagram illustrating a structure of the image forming portion of the first embodiment. As shown in FIG. 2, the image forming portions 18Y, 18C, 18M and 18Bk are configured in the same manner except that the colors of the toners used in developing units 208Y, 208C, 208M and 208Bk are different. Accordingly, only the image forming portion 18Y will be described below and an overlapped explanation concerning the image forming portions 18C, 18M and 18Bk will be omitted here.

The image forming portion 18Y includes a charging roller 206Y, an exposure unit 21, a developing unit 208Y, a primary transfer roller 209Y, and a drum cleaning unit 213Y disposed around a photoconductive drum 20Y.

The photoconductive drum 20Y is what a photoconductive thin film whose charge polarity is negative is formed around a peripheral surface of a base body made of aluminum and rotates at a predetermined processing speed. The charging roller 206Y is applied with vibration voltage in which AC voltage is superimposed on DC voltage and charges the peripheral surface of the photoconductive drum 20Y with a homogeneous negative potential.

The exposure unit 21 is configured to form an electrostatic image of the image by scanning a laser beam binary-modulated corresponding to an image signal of a scan line on a peripheral surface of the photoconductive drum 20Y. The developing unit 208Y is configured to develop the electrostatic image by using a two-component developer containing toner and carrier and to develop a toner image on the photoconductive drum 20Y.

The primary transfer roller 209Y is applied with positive DC voltage and transfers the toner image on the photoconductive drum 20Y to the intermediate transfer belt 10. The drum cleaning unit 213Y is configured to recover remaining toner in the transfer operation by bringing a cleaning blade into contact with the intermediate transfer belt 10.

As shown in FIG. 1, the image forming apparatus 1 also includes a document reading apparatus 201, an area specifying unit 202, a print controller 203, and a control portion 800. The document reading apparatus 201 is configured to read an image of a document placed on a platen by sensing a reflection light from a surface of the document by a CCD line sensor. The area specifying unit 202 is configured to be operated by an operator to define a document reading area and others. The print controller 203 outputs a print signal based on image data of a personal computer or the like not shown. By receiving signals from the document reading apparatus 201, the area specifying unit 202, the print controller 203 and others, the control portion 800 executes signal processing of sending a command to each part of an image output mechanism and controls various imaging sequences.

In response to a start button of the image forming apparatus 1 pressed by a user, the document reading apparatus 201 reads image information of a document. When the image information is sent from the document reading apparatus 201 to the control portion 800, the control portion 800 controls each portion based on the image information and executes an image forming operation. The control portion 800 perceives positions of dots composing an image to be formed per each color from the image information and sends the dot information to the exposure unit 21. Then, the exposure unit 21 forms dot-like electrostatic images on the photoconductive drums 20Y, 20C, 20M, and 20Bk corresponding to the respective colors.

### (Intermediate Transfer Belt)

The intermediate transfer belt 10 is stretched around a drive roller 14, a tension roller 15, and a secondary transfer inner roller 16. The intermediate transfer belt 10 is driven by the drive roller 14 and is rotated in a direction of an arrow R2 shown in FIG. 2. A secondary transfer outer roller 22 and a tension roller 23 stretch the transfer belt 24.

The secondary transfer outer roller 22 is biased by its both ends toward the secondary transfer inner roller 16 so that a toner image secondary transfer portion T2 is formed between the intermediate transfer belt 10 and the transfer belt 24. The secondary transfer portion T2 is configured to fix an image to the recording medium P by pressing a toner image containing a fixing solution to the recording medium P to impregnate the fixing solution to the toner image and to secondarily transfer the toner image to the recording medium P in the same time.

Water-repellent finishing such as fluoridation is implemented on a surface of the intermediate transfer belt 10 to give required water-repellency to the surface. Preferably, the required water-repellency is such a level that a contact angle to water is 60° or more. That is, if the surface of the intermediate transfer belt 10 has enough water-repellency and even if the fixing solution (sub-droplet 104b) adheres on a part of the surface of the intermediate transfer belt 10 carrying no toner image, the fixing solution is absorbed and collected by near-by toners and the fixing solution on that part of the intermediate transfer belt 10 is vanished. Accordingly, the water-repellent finish enables the fixing solution not to be wastefully adhered on the part of the surface of the intermediate transfer belt 10 carrying no toner even if a control on a fixing solution (sub-droplet 104d) supply area of the fixing solution supplying unit 90 is inaccurate more or less.

### (Fixing Solution)

The fixing solution is a liquid containing a water-soluble polymer and water and whose viscosity is higher than that of water. The water-soluble polymer may be any water-soluble polymer as long as it is a hydrophilic material whose refractive index is close to a resin used in the toner and which is less influential to color. Specific examples of the water-soluble polymer include polyvinyl alcohol, polystyrene acrylic acid, polyacrylate, polyglycerin, polyurethane, polyacrylamide and others. Among them, polyurethane is preferable because it has a higher binding force and higher friction resistance when it is solidified as it is used for painting an outdoor object. It is also possible to use a water-soluble ultraviolet ray hardening resin as described in Japanese Patent Application Laid-open No. 2008-276037 as a matter of course when it is desirable to enhance the friction resistance, water resistance and others. Such a case may be accommodated by appropriately providing a mechanism configured to irradiate ultraviolet rays after or during applying the fixing solution.

A surfactant may be added to the fixing solution to disperse the water-soluble polymer component in water. Specific examples of the surfactant include an anionic surfactant such as fatty acid derivative sulfate ester, sulfonic acid type, and phosphate ester; a cationic surfactant such as quaternary ammonium salt, heterocyclic amine, and amine derivative; an amphoteric ion (nonionic) surfactant such as amino acid ester, amino acid, and sulfobetaine; a nonionic surfactant, polyoxyalkylene alkyl ether, polyoxyethylene alkylamine, and the like. It is also possible to add various water-soluble solvents for the purpose of adjusting the viscosity and surface tension. The followings are specific examples of the water-soluble solvent:

(1) An 1-5C alkyl alcohol group such as methyl alcohol, ethyl alcohol, n-propyl alcohol, isopropyl alcohol, n-butyl alcohol, sec-butyl tert-butyl alcohol, isobutyl alcohol, and n-pentanol alcohol; and an amide group such as dimethylformamide and dimethylacetamide:

(2) keton or ketoalcohol such as acetone and diacetone alcohol; and ethers such as tetrahydrofuran and dioxane:

(3) an oxyethylene or oxypropylene copolymer such as diethylene glycol, triethylene glycol, tetraethylene glycol, dipropylene glycol, tripropylene glycol, polyethylene glycol, and polypropylene glycol:

(4) an alkylene glycol in which alkylene group contains 2-6C such as ethylene glycol, propylene glycol, trimethylene glycol, triethylene glycol, and 1,2,6-hexanetriol; and glycerin:

(5) trimethylolethane and trimethylolpropane; lower alkyl ethers such as ethylene glycol monomethyl (or ethyl) ether, diethylene glycol monomethyl (or ethyl) ether, and triethylene glycol monomethyle (or ethyl) ether;

(6) lower dialkylethers of poly-hydric alcohol such as triethylene glycol dimethyl (or ethyl) ether, and tetraethylene glycol dimetyl (or ethyl) ether: and

(7) an alkanolamine group such as monoethanolamine, diethanolamine, and triethanolamine.

Still further, sulfolane, N-methyl-2-pyrrolidone, 2-pyrrolidone, and 1,3-dimetyl-2-imidazolidinone may be cited. The abovementioned water-soluble solvent may be used solely or as a mixture.

According to the first embodiment, the image is fixed to the recording medium by filling up gaps between toner particles of the toner image by the water-soluble polymer without dissolving or softening by swelling the toner particles. Due to that, it is necessary to supply the fixing solution by an amount sufficient to fill up the gaps of the toner particles by the water-soluble polymer in order to assure not only fixability to the recording medium but also coloring properties (refraction index) of the image.

However, because the fixing solution contains water, there is a possibility that a tissue of a sheet is loosened and the recording medium is curled if an excessive amount of the fixing solution is supplied. It is desirable to limit an amount of moisture supplied to a recording medium to be 15 g/m² or less or more preferably to be 10 g/m² or less in order not to cause a curl in the recording medium of a plain sheet when no moisture is evaporated by heating or the like (Japanese Patent Application Laid-open No. 2006-110930). The moisture content is around 0.9 g at most or is preferable to be around 0.63 g per one A4-size sheet. Because the moisture content supplied to a sheet is important, it is possible to increase an amount applied to the sheet if evaporation of moisture is expedited by heating, warm air or the like on the intermediate transfer body.

It is noted that such a mechanism that applies heat or warm air is not provided in the present embodiment. It is because it is not preferable to supply energy to evaporate the moisture from an aspect of energy saving because this arrangement increases energy consumption as a result.

Due to that, it is necessary to arrange such that the fixing solution has such concentration of the water-soluble polymer that meets the limit of the supplied moisture content while meeting the required amount of the water-soluble polymer component in the first embodiment. An optimal amount (g) per unit area of the water-soluble polymer to be supplied to a non-fixed toner image can be estimated by the following equation:

$${n}_{p} = \frac{{D}_{1} \times 10 \times ɛ}{{ρ}_{1}} \times {ρ}_{p} \qquad Eq . 1$$

where, nₚ is weight [g] of water-soluble polymer, ρₚ is density of water-soluble polymer [g/m³], Dₜ is a toner maximum loading amount [mg/cm²], ρₜ is toner density [g/m³], and ε is a porosity of a toner layer.

In Equation 1 described above, the porosity ε of a non-fixed toner image does not take a value of a most densely filled state and is around 0.4 to 0.5. The density ρₚ of the water-soluble polymer is almost in a same level with the toner density ρₜ. Due to that, a required amount of water-soluble polymer to be supplied per unit area nₚ is determined by the toner maximum loading amount Dₜ.

As indicated by Equation 1 described above, it is better to reduce the toner maximum loading amount Dₜ in order to reduce the content of the water-soluble polymer. However, if the toner maximum loading amount Dₜ is too small, it is not preferable because a white background of the recording medium may be exposed and image density may be damaged. The lowest possible toner maximum loading amount Dₜ which will not expose the white background of the recording medium is around 0.7 mg/cm² in the most densely filled state.

Accordingly, the maximum amount nₚ of the water-soluble polymer supplied per unit area is substantially 2.9 to 3.6 g/m². In order to suppress the moisture content in which 2.9 to 3.6 g/m² of water-soluble polymer is dissolved to 15 g/m², density of the water-soluble polymer in the fixing solution increases to 20 to 24% or more. It is difficult to form fine liquid droplet particles (mists) from such a highly viscous aqueous solution by a normal atomizer, an ultrasonic vibrating plate, a piezoelectric vibrating plate or the like.

It is also difficult to reduce an aperture of a nozzle in using such highly viscous aqueous solution because viscous resistance increases in using an inkjet head. Then, a diameter of a main droplet exceeds 20 μm even if injection conditions are variously changed. Therefore, main droplets are removed from liquid particles of the fixing solution injected by an inkjet head and sub-droplets whose diameter is smaller than that of the main droplets are supplied to a toner image in the first embodiment.

### (Fixing Process)

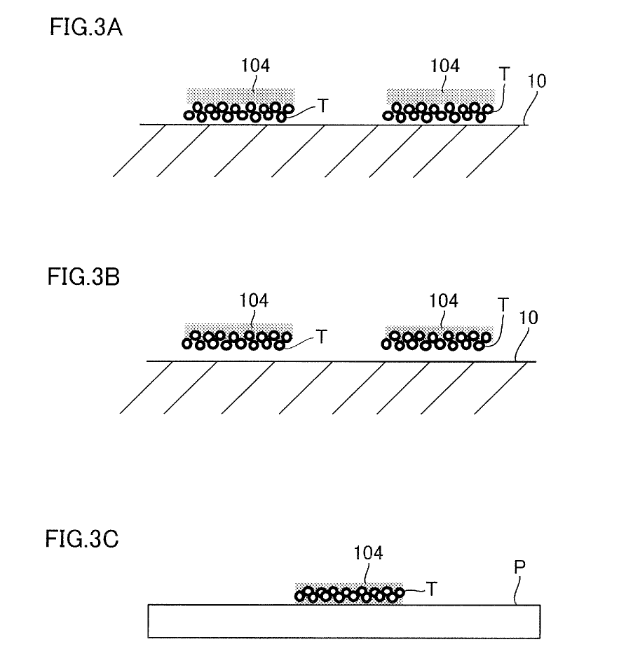

FIGS. 3A, 3B and 3C illustrate a fixing process in the first embodiment. As shown in FIG. 3A, the intermediate transfer belt 10 which is one exemplary intermediate transfer body carries a toner image, and liquid particles of the fixing solution 104 are supplied to the toner image T carried on the surface of the intermediate transfer belt 10 by using the inkjet head from the fixing solution supplying unit 90 (see FIG. 1) in a first step. The liquid particles of the fixing solution 104 adhere on toner parts on the intermediate transfer belt 10.

In a second step, droplet particles of the fixing solution containing a water-soluble polymer of urethane resin and water is supplied to the toner image on the intermediate transfer belt 10 and as the fixing solution 104 is applied to the toner image T, the fixing solution 104 impregnates into a toner layer as shown in FIG. 3B. Then, along with a move of the surface of the intermediate transfer belt 10, the toner image T is conveyed to the secondary transfer portion T2 forming a nip by the intermediate transfer belt 10 and the transfer belt 24. Then, the toner image T and the fixing solution on the intermediate transfer belt 10 are pressed on a surface of the recording medium P in the secondary transfer portion T2.

In a third step, the toner image T on the intermediate transfer belt 10 on which the liquid droplet particles of the fixing solution have been supplied is transferred to the recording medium P under pressure as shown in FIG. 3C. The pressurization increases density of the toner particles and fills up the voids by the water-soluble polymer. As the fixing solution impregnates further into the toner layer, extra moisture is absorbed by the recording medium (sheet of paper). Then, the polymer component remains in the voids of the toner and adhesiveness of the polymer permits the polymer to be fixed on the recording medium P as it is transferred to the recording medium P.

### (Fixing Solution Supplying Unit)

FIGS. 4A and 4B are schematic diagrams illustrating dispositions of the fixing solution supplying unit 90. As shown in FIG. 4A, the fixing solution supplying unit 90 is disposed apart from the surface of the intermediate transfer belt 10 by a small interval between the drive roller 14 and the secondary transfer portion T2, and supplies the fixing solution to the toner image on the intermediate transfer belt 10 before the toner image is secondarily transferred.

As shown in FIG. 4B, a fixing solution injecting portion 101 faces a main droplet recovering portion 102 with a small interval in the fixing solution supplying unit 90. That is, the fixing solution supplying unit 90 is configured such that among main droplets and sub-droplets injected out of the fixing solution injecting portion 101, the main droplets are recovered by the main droplet recovering portion 102 and the sub-droplets are supplied to the toner image on the intermediate transfer belt 10.

It is known in an inkjet type image forming apparatus that liquid droplets injected out of micropores of the inkjet head are fragmented into large and small liquid droplets. Among the fragmented liquid droplets, largest droplets are referred to as main droplets and other small droplets are referred to sub-droplets (satellite liquid droplets). Conventionally, an image is formed by solely using main droplets and various discharge conditions are set such that unwanted sub-droplets are minimized in the inkjet type image forming apparatus. It is because the sub-droplets adhere on unpredictable parts on a recording medium or on parts of a casing of the apparatus, thus causing a contamination of the apparatus, by losing their speed in air after injection. The inkjet type image forming apparatus is being technologically developed in a direction of cutting the sub-droplets. Because the present embodiment utilizes the satellite droplets, the jet head may be any jet head as long as it fragments discharged droplets into at least main droplets and satellite droplets, and a conventional ink head adopted in an inkjet recording type printer may be used. Therefore, a commercially available ink head for use in inkjet is used in the first embodiment.

Still further, various discharge conditions may be set such that the more fixing solution is formed into the sub-droplets by lowering a rate by which the fixing solution congregates as the main droplets in order to efficiently supply the fixing solution to the toner image by utilizing the sub-droplets. For instance, the faster the injection velocity of the fixing solution, the more the sub-droplets are produced.

It is also effective to increase the viscosity of the fixing solution, to lower static or dynamic surface tension thereof in order to enhance the production rate of the sub-droplets.

### (Fixing Solution Inject Portion)

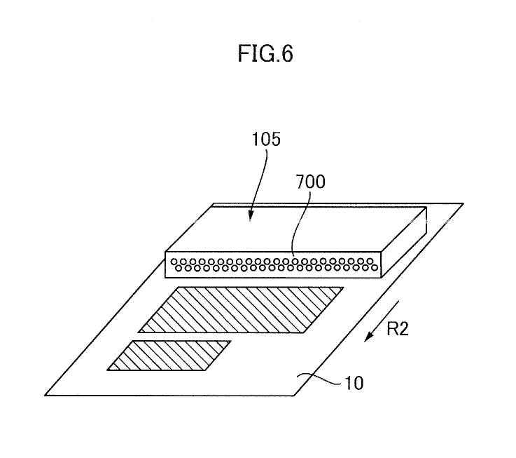

FIG. 5 is a schematic diagram illustrating a configuration of a fixing solution injecting portion 101, and FIG. 6 is a perspective view showing a disposition of a jet head 105. As shown in FIG. 5, the fixing solution injecting portion 101 stores the fixing solution 104 within a fixing solution reservoir 106. The fixing solution 104 is supplied to each injection element of the jet head 105 through a fixing solution supplying pipe 107. Conventional heating type or piezo type element can be used as the injection element. The jet head may be any head as long as injected liquid droplets are fragmented into main and sub droplets, and an ordinary ink head adopted in the inkjet type image forming apparatus may be used.

As shown in FIG. 6, the jet head 105 injects the fixing solution 104 out of each micropore within in a range corresponding to a width of a recording medium (or an area of an image) among a large number of micropores 700 arrayed in a width direction of the intermediate transfer belt 10, i.e., in a direction orthogonal to a conveying direction thereof. The fixing solution 104 is injected out of the micropores 700 substantially in parallel with a direction in which the intermediate transfer belt 10 advances.

As shown in FIG. 5, the fixing solution injected pulsewise out of the micropore of the jet head 105 comes into a main droplet 104a by congregating into a globular shape in air by surface tension. In the same time, the fixing solution comes also into sub-droplets 104 by fragmenting into large and small liquid droplets on a same principle with that water of a fountain is fragmented into fine liquid droplets. Only the sub-droplets 104b of the fixing solution 104 are simply and stably supplied to the non-fixed toner image the main droplets 104a of the fixing solution 104 are solely recovered by the main droplet recovering portion 102 to be recycled in the fixing solution supplying unit 90.

### (Main Droplet Recover Portion)

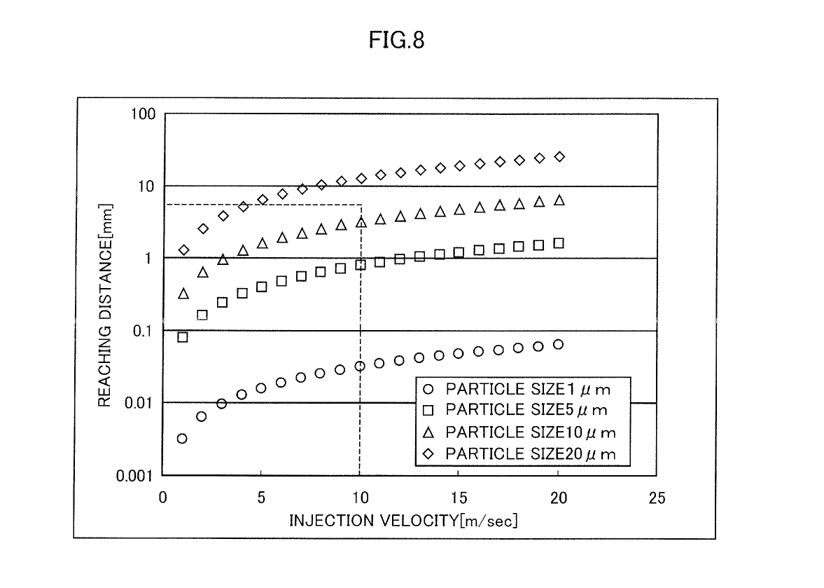

FIG. 7 is a schematic diagram illustrating a configuration of the main droplet recovering portion 102, and FIG. 8 is a graph explaining a relationship between an injection velocity and a reaching distance of liquid droplet particles of the fixing solution. As shown in FIG. 7, the fixing solution injecting portion 101 and the main droplet recovering portion 102 are disposed such that the intermediate transfer belt 10 is not positioned on an injection orbit of the main droplets so that the main droplets injected out of the fixing solution injecting portion 101 do not contact with and impede the rotation of the intermediate transfer belt 10.

A distance between the fixing solution injecting portion 101 and the main droplet recovering portion 102 is set at a distance that permits to recover the main droplets and excessively large sub-droplets, e.g., sub-droplets larger than toner particles. The main droplets and sub-droplets injected out of the fixing solution injecting portion 101 advance in air while receiving an influence of air resistance. Due to that, the smaller the sub-droplet, the more quickly its speed decelerates after the injection and its final advance distance is shortened. Viscosity resistance R in a case when a liquid droplet particle floats in air can be calculated from the Stoke's law of resistance by Equation 2. In Equation 2, r denotes a radius of a particle, ν denotes particle velocity, and η denotes a coefficient of viscosity of air.

R=6πrνη Eq.2

Assuming that a particle is injected with velocity ν₀ in a horizontal direction vertical to a direction of gravity and that there is no air flow or the like, velocity ν at a flying time t after the injection can be calculated by the Equation 3. In Equation 3, m denotes a mass of the particle.

$$v = {v}_{0} exp ( - \frac{6 π r η}{m} t ) \qquad Eq . 3$$

As indicated by Equation 3, a distance to which the particle can advance in the horizontal direction is limited and a reaching distance d, i.e., its maximum distance, can be calculated by Equation 4.

$$d = \frac{{mv}_{0}}{6 π r η} \qquad Eq . 4$$

Accordingly, it is possible to separate the sub-droplets and main droplets whose diameter is larger than a diameter of required sub-droplets, e.g., a diameter smaller than that of a toner particle, and to recover them by the main droplet recovering portion 102 by setting the reaching distance d corresponding to the diameter of the required sub-droplets as the distance between the fixing solution injecting portion 101 and the main droplet recovering portion 102. That is, it is possible to predict the reaching distance d to which a liquid droplet particle whose radius is r and injected with initial velocity ν₀ while receiving only viscosity resistance can reach by a certain degree by using Equation 4.

As shown in FIG. 8, the larger the diameter of the liquid droplet of the fixing solution, the greater the reaching distance d is in fact. Still further, the faster the injection velocity (initial velocity ν₀ of the injection), the greater the reaching distance d is. For instance, if the diameter of the main droplet is 20 μm and that of the sub-droplet is 10 μm or less in injecting the fixing solution with 10 m/sec. of initial velocity, the distance d may be set at around 10 μm. Thus, the distance between the fixing solution injecting portion 101 and the main droplet recovering portion 102 opposing to each other is set corresponding to the diameter of the sub-droplets to be supplied to the toner image on the intermediate transfer body, and these main droplets and sub-droplets are separated corresponding to the difference of the reaching distances of the main droplet and sub-droplet injected out of the fixing solution injecting portion 101.

As shown in FIG. 7, the main droplet recovering portion 102 is connected with the fixing solution injecting portion 101 through a fixing solution tube 109. The fixing solution of the main droplets received and recovered by the main droplet recovering portion 102 is suctioned by a pump 110 through the fixing solution tube 109 and is supplied to a fixing solution reservoir 106 of the fixing solution injecting portion 101 to be used and injected again out of the fixing solution injecting portion 101. It is possible to suppress a consumption amount and an amount of waste of the fixing solution also in the present invention not using the main droplets by recycling the fixing solution of the main droplets that amounts a considerable amount of the injected fixing solution.

The pump 110 is disposed at a level lower than the main droplet recovering portion 102. Due to that, the fixing solution recovered by the main droplet recovering portion 102 naturally flows into the pump 110 in accordance of a direction of the gravity, so that the recovery of the fixing solution can be easily made. A tube pump for use in conveying a viscous liquid is used as the pump 110. The tube pump is preferable also from a point of preventing the fixing solution from being evaporated unnecessarily otherwise in contact with air. A lid not shown is automatically attached to the main droplet recovering portion 102 when no printing operation is carried out for a predetermined time to prevent the recovered fixing solution from been aggregated or solidified.

### (Electric Field Applying Portion)

As shown in FIG. 4A, the fixing solution supplying unit 90 supplies the sub-droplets to the toner image going against the gravity in the image forming apparatus 1, so that an electric field applying unit 103 is disposed inside the intermediate transfer belt 10 to electrically attract the sub-droplets to the intermediate transfer belt 10. That is, the electric field applying unit 103 charges the intermediate transfer belt 10 to electrically attract particles of the sub-droplets. The sub-droplets generated in the fixing solution supplying unit 90 head toward the toner image on the intermediate transfer belt 10 by being biased by an electric field formed by the electric field applying unit 103 between the intermediate transfer belt 10 and the fixing solution supplying unit 90, i.e., the electric field is formed between the space between the fixing solution injecting portion and the recovery member and the image carrier.

The electric field applying unit 103 positively charges the intermediate transfer belt 10 by irradiating plus ions associated with corona discharge to an inner surface of the intermediate transfer belt 10. That is, the electric field applying unit 103 forms such an electric field that heads the sub-droplets having minus charge to the intermediate transfer belt 10 between the fixing solution supplying unit 90 and the intermediate transfer belt 10. The surface of the intermediate transfer belt 10 is charged with the polarity opposite from the electrification charge of the sub-droplets to attract the floating sub-droplets to the toner image by the electric field created by the electrification charge. Among the main droplet and sub-droplet of the fixing solution injected out of the jet head 105, the sub-droplets are absorbed and adsorbed to the non-fixed toner image by the electric field created by the electric field applying unit 103 and become ready to be fixed to the recording medium.

There is known such a phenomenon (Lenard Effect) that internally polarized liquid droplets are apt to be electrified either to plus or minus, in particular to minus, when the droplets are torn off or collide with each other in a process of forming (spraying) liquid droplet particles containing water. Due to that, it is possible to acquire a force that attracts the sub-droplets just by positively charging the intermediate transfer belt 10 without expressly charging the sub-droplets. It is noted that a corona electrifier may be provided also on a side of the fixing solution supplying unit 90 to charge the liquid droplets of the fixing solution to a polarity opposite to that of the intermediate transfer belt 10.

Note that the toner particles of the toner image are desirable to be negatively charged in positively charging the intermediate transfer belt 10. It is because the toner image may be disturbed if the toner particles are positively charged in positively charging the intermediate transfer belt 10. The method for forming the electric field is not specifically limited. For instance, the electric field applying unit 103 may be an electrode plate to which positive DC voltage is applied.

### (Control of Fixing Solution Supplying Unit)

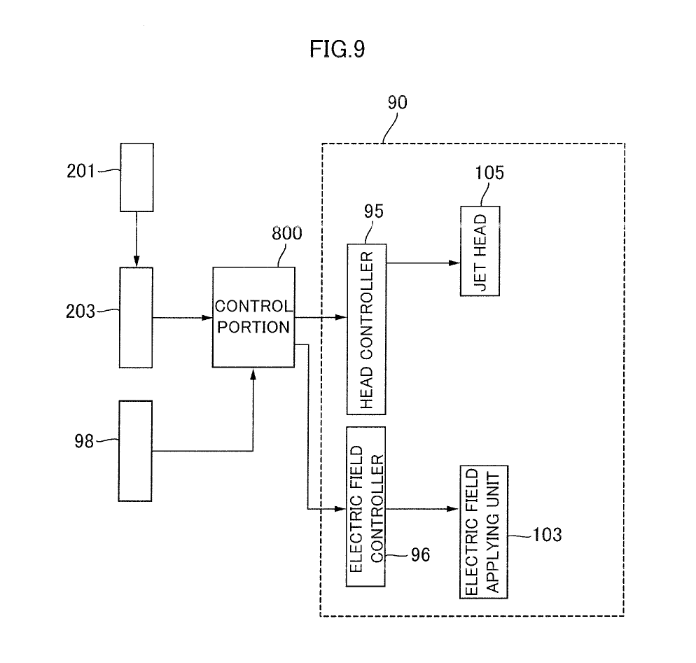

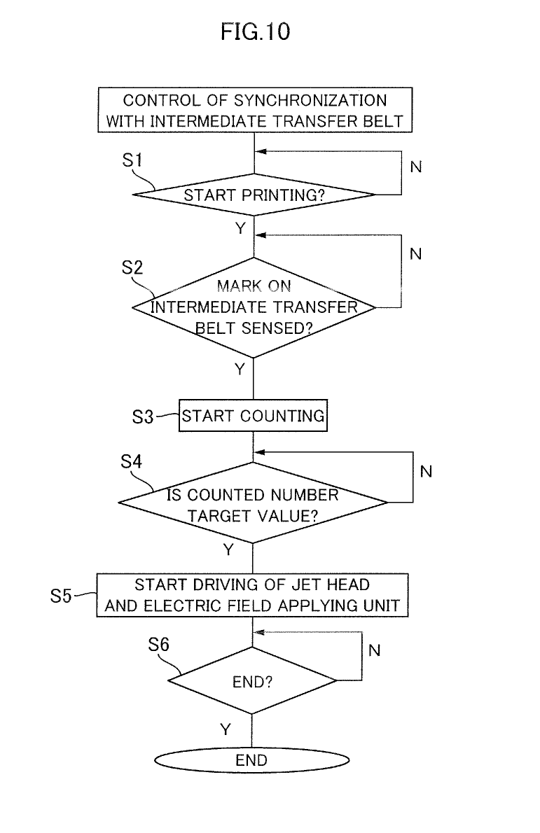

FIG. 9 is a control block diagram of the fixing solution supplying unit, and FIG. 10 is a flowchart of the control of the fixing solution supplying unit. As shown in FIG. 9, the control portion 800 controls a head controller 95 to inject the fixing solution out of the jet head 105. In accordance to a command of the control portion 800, the head controller 95 controls the injection of the fixing solution 104 injected out of the jet head 105. The control portion 800 also control an electric field controller 96 to irradiate electrically charged particles from the electric field applying unit 103 to the intermediate transfer belt 10. The electric field controller 96 controls a charged state of the intermediate transfer belt 10 charged by the electric field applying unit 103 in accordance to a command of the control portion 800.

As shown in FIG. 4A, the control portion 800 detects a detection mark 99 provided on a back of the intermediate transfer belt 10 by a mark sensor 98. The control portion 800 figures out a front end position of the toner image on the intermediate transfer belt 10 by starting an image forming operation on a timing of the detection mark 99 detected by the mark sensor 98. The control portion 800 judges a timing when the front end position of the toner image on the intermediate transfer belt 10 reaches the position where the jet head 105 to the electric field applying unit 103 by an elapsed time from the timing detected by the mark sensor 98. The control portion 800 supplies the sub-droplets 104b of the fixing solution injected out of the jet head 105 considerably accurately to the toner image on the intermediate transfer belt 10 whose surface is moved by actuating the jet head 105 in synchronism with the moving position of the surface of the intermediate transfer belt 10. Thereby, the control portion 800 avoids the fixing solution from being wastefully applied on the intermediate transfer belt 10.

The control portion 800 outputs dot information outputted to the exposure unit 21 also to the head controller 95 and the electric field controller 96 of the fixing solution supplying unit 90. Based on the dot information, the head controller 95 injects the fixing solution 104 out of the jet head 105 when the surface of the intermediate transfer belt 10 on which the toner is adhered arrives at a jet position of the jet head 105. The electric field controller 96 actuates the electric field applying unit 103 to apply the intermediate transfer belt 10 with electric charges to charge the intermediate transfer belt 10 with a polarity opposite from that of the sub-droplets when a back surface of the intermediate transfer belt 10 on which the toner is adhered arrives at the electric field applying unit 103 also based on the dot information. When the back surface of the intermediate transfer belt 10 on which the toner is adhered arrives at the electric field applying unit 103, the electric field controller 96 actuates the electric field applying unit 103 to apply the intermediate transfer belt 10 with the electric charges to charge the intermediate transfer belt 10 with the polarity opposite to that of the sub-droplets based on the dot information.

A part of the sub-droplets 104b among the fixing solution 104 injected out of the jet head 105 leaks out of the space between the fixing solution injecting portion 101 and the main droplet recovering portion 102 and floats in air. The sub-droplets floating in air are guided to the toner image on the intermediate transfer belt 10 by the electric field created by the electrified charge of the intermediate transfer belt 10. Thus, the fixing solution is supplied to the toner image.

This process will be explained in detail below with reference to FIGS. 4A and 10. When a user presses a start switch (S1), the control portion 800 starts to rotationally drive the intermediate transfer belt 10, the photoconductive drums 20Y, 20C, 20M, and 20Bk, and the transfer belt 24.

When the mark sensor 98 detects the detection mark 99 (S2), the control portion 800 resets a control counter and starts to count anew (S3). When a count value of the counter reaches a target value (S4), the control portion 800 starts to supply the fixing solution by the jet head 105 to form the electric field by the electric field applying unit 103 (S5). The target value corresponds to a time until when the front end position of the toner image on the intermediate transfer belt 10 reaches the position facing the jet head 105.

Based on the count value of the counter, the control portion 800 actuates the jet head 105 and the electric field applying unit 103 until when a rear end of the toner image on the intermediate transfer belt 10 passes through the position facing the jet head 105 (N in S6) and ends the control (Y in S6).

### (Control on Supplied Quantity of Fixing Solution)

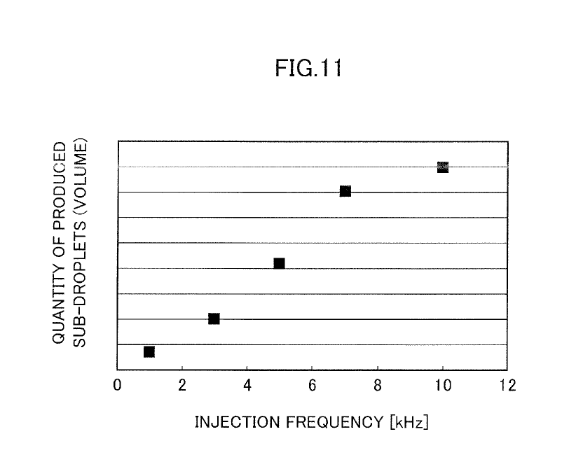

FIG. 11 is a graph explaining a relationship between injection frequency of the jet head and a produced quantity of sub-droplets. Because it is necessary to suppress a quantity of the fixing solution applied to the recording medium to a level not causing a curl in the recording medium, the control portion 800 controls a quantity of the fixing solution to be applied to the toner image and an application range corresponding to image information to keep them at minimum required levels.

As shown in FIG. 11, the fixing solution supplying unit has a proportional relationship between the injection frequency of the jet head 105 and the produced quantity of sub-droplets per unit time. Therefore, the higher the density of an image and the more the toner loading amount, the more the control portion 800 increases the amount of the fixing solution to be supplied by increasing the injection frequency of the jet head 105. Meanwhile, if the density of an image is low and a toner loading amount is small, the control portion 800 lowers the injection frequency of the jet head 105 to save an amount of the fixing solution to be supplied. The control portion 800 has the relationship between the injection frequency and the produced quantity of sub-droplets as a table in advance and controls the injection frequency of the jet head 105 corresponding to the dot information described above.

It is noted that the image forming operation may be executed by actually differentiating the injection frequency and by supplying the fixing solution to a non-fixed toner image as one adjusting mode of the image forming apparatus. The relationship between the injection frequency and the supplied amount of sub-droplets may be found on site by analyzing an image formed on a recording medium.

### First Example

Next, a first example in which the image forming operation was carried out by using a following first fixing solution in an image forming apparatus in which the fixing solution supplying unit 90 of the first embodiment is manufactured as follows will be explained.

### (First Fixing Solution)

(a) polystyrene acrylic acid RS-1191 (manufactured by Seiko PMC Corporation) 30 wt. %

(b) polyoxyethylene alkyl ether-based surfactant ID-206 (manufactured by NOF Corporation) 1 wt. %

(c) water 69 wt. %

The first fixing solution was prepared by mixing and agitating these compounds. The fixing solution showed a transparent property, and viscosity of the fixing solution was 25 mPa·sec (corn and plate: φ60.1°). The viscosity of the fixing solution was measured by using a RE80L viscometer (manufactured by Toki Sangyo) at 25° C.

As shown in FIG. 5, the jet head 105 of the fixing solution supplying unit 90 injects the liquid droplets of the fixing solution from the micropores by piezoelectric elements.

As shown in FIG. 6, the jet head 105 of a stationary line head was used. A distance between the jet head 105 and the intermediate transfer belt 10 is 1 mm. An injection direction of the jet head 105 is in parallel with a direction of rotation of the intermediate transfer belt 10.

It was confirmed from image analysis of high-speed photography that the injection velocity of the main droplet 104a injected out of the micropore of the jet head 105 was about 12 m/sec. A diameter of the main droplet 104a was about 20 μm. Together with one main droplet 104a, four to five sub-droplets 104b were generated. An average diameter of the sub-droplets 104b was about 10 μm.

As shown in FIG. 7, the main droplet recovering portion 102 was disposed to face the micropores of the jet head 105 so that the main droplet recovering portion 102 can efficiently recover the main droplets, and a distance between the jet head 105 and the main droplet recovering portion 102 was set to 10 mm. This arrangement made it possible to favorably separate the main droplets from the sub-droplets.

The fixing solution recovered from the main droplet recovering portion 102 flows into the fixing solution tube 109 by its own weight and is conveyed to the fixing solution reservoir of the fixing solution injecting portion 101 by the supply pump 110. The fixing solution tube 109 is a commercially available silicon tube, and the supply pump 110 is also a commercially available roller pump. This arrangement made it possible to reuse the recovered fixing solution favorably.

A slit nozzle 116 is disposed in the space between the jet head 105 and the main droplet recovering portion 102 to blow air from the fan 115 through the slit nozzle 116 so that the sub-droplets head efficiently toward the intermediate transfer belt 10. The fan 115 selected here was that of air quantity that does not bend orbits of the main droplets among commercially available computer cooling fans. The air quantity was 0.1 m³/min. The air quantity was optimized by overlapping a plurality of filters on the fan 115.

The electric field applying unit 103 was disposed to face the inner surface of the intermediate transfer belt 10. The electric field applying unit 103 used here was a scorotron. The electric field applying unit 103 applied negative charges to the back surface of the intermediate transfer belt 10 to positively charge the surface of the intermediate transfer belt 10. It was confirmed that the negatively charged sub-droplets are led to the surface of the intermediate transfer belt 10 when applied voltage of the scorotron was set to 6 kV.

A fixed image having a favorable coloring property and a relatively favorable fixability could be obtained when the fixing solution supplying unit 90 was actuated to execute the image forming and fixing processes in accordance to the abovementioned sequence.

Because the main droplets are not supplied to and the sub-droplets whose particle size is small are supplied to the toner image on the intermediate transfer belt 10 in the image forming apparatus 1 described above, a distribution of quantities of the fixing solution supplied to micro areas of the toner image becomes homogeneous as compared to a case of supplying the main droplets having a large particle size. Accordingly, it is possible to reduce damages on the toner image as compared to a case of injecting and impacting the main droplets having the large particle size at high speed to the toner image.

The fixing solution is supplied on the toner image part on the recording medium and no fixing solution is supplied to the surface of the recording medium on which the toner image is not adhered in the image forming apparatus 1. Due to that, as compared to a so-called wet type image forming apparatus in which a fixing solution is applied to a whole recording medium, it is possible to reduce an amount of the fixing solution impregnated into the recording medium and to suppress the recording medium from curling or causing wrinkles.

Because a volume of solidified part contained in the quantity of the fixing solution supplied per unit area is greater than a volume of voids per unit area of a toner image in the image forming apparatus 1, it is possible to suppress light from scattering otherwise caused by remaining voids within a toner layer and to improve fixability and coloring property of the fixed image of the toner image.

The fixing solution supplying unit 90 can also supply the small liquid droplets easily and reliably to the toner image without reducing a diameter of the micropores to reduce the size of the main droplets and without lowering reliability and efficiency as a jet head. Because the fixing solution supplying unit 90 uses the established inkjet type jet head, the fixing solution supplying unit 90 can supply the microscopic liquid droplet particles of the fixing solution easily and stably to the non-fixed toner image.

Because the fixing solution supplying unit 90 recovers the fixing solution of the separated main droplets and circulates the fixing solution to the jet head 105 to use again, the fixing solution may be consumed efficiently as compared to a case of dumping the separated main droplets.

The fixing solution supplying unit 90 can form the liquid droplet particles of less than 15 μm in diameter as the sub-droplets even though the fixing solution whose main component is water contains the water-soluble polymer of high concentration. Due to that, the fixing solution supplying unit 90 can provide the high quality fixed image having the favorable fixability and coloring property without causing waviness or the like of the recording medium while suppressing the toner images from scattering otherwise caused by the liquid droplet particles of the fixing solution.

Accordingly, the fixing solution supplying unit 90 can output the fixed image having the favorable fixability and coloring property by supplying the fixing solution without causing scattering or the like of the toner image while appropriately controlling the quantity of the fixing solution to be supplied of the microscopic liquid droplets corresponding to density of an image even if the viscosity of the fixing solution is high.

### Second Example

An image forming operation was executed by fabricating the fixing solution supplying unit 90 of the first embodiment as follows and by using a following second fixing solution in a second example.

### (Second Fixing Solution)

(a) polyurethane W-6010 (manufactured by Mitsui Chemicals, Inc.) 30 wt. %

(b) polyoxyethylene alkyl ether-based surfactant ID-206 (manufactured by NOF Corporation) 1 wt. %

(c) water 69 wt. %

The second fixing solution was prepared by mixing and agitating these compounds. The fixing solution showed a transparent property, and viscosity of the fixing solution was 21 mPa·sec (corn and plate: φ60.1°). The viscosity of the fixing solution was measured by using a RE80L viscometer (manufactured by Toki Sangyo) at 25° C.

As shown in FIG. 5, the jet head 105 of the fixing solution supplying unit 90 is constructed in the same manner with that of the first example.

As shown in FIG. 6, the disposition of the jet head 105 and the distance from the intermediate transfer belt 10 are the same with those of the first example.

It was confirmed from image analysis of high-speed photography that the injection velocity of the main droplet 104a injected out of the micropore of the jet head 105 was about 13 m/sec. A diameter of the main droplet 104a was about 20 μm. Together with one main droplet 104a, three to four sub-droplets 104b were generated. An average diameter of the sub-droplets 104b was about 10 μm.

As shown in FIG. 7, the configuration related to the main droplet recovering portion 102, the fixing solution tube 109, and the supply pump 110 is the same with that of the first example. The configuration related to the slit nozzle 116 and the fan 115 is also the same with that of the first example. The configuration related to the electric field applying unit 103 is the same with that of the first example.

It was confirmed that the fixing solution recovered by the main droplet recovering portion 102 can be favorably reused and that the sub-droplets negatively charged are led to the surface of the intermediate transfer belt 10 when applied voltage of the scorotron was 6 kV in the same manner with the first example.

A fixed image having a favorable coloring property and a relatively favorable fixability and scratch resistance in particular as compared to those of the first example could be obtained when the fixing solution supplying unit 90 was actuated in the same manner with the first example to execute the image forming and fixing processes in accordance to the abovementioned sequence.

### Modified Example of First Embodiment

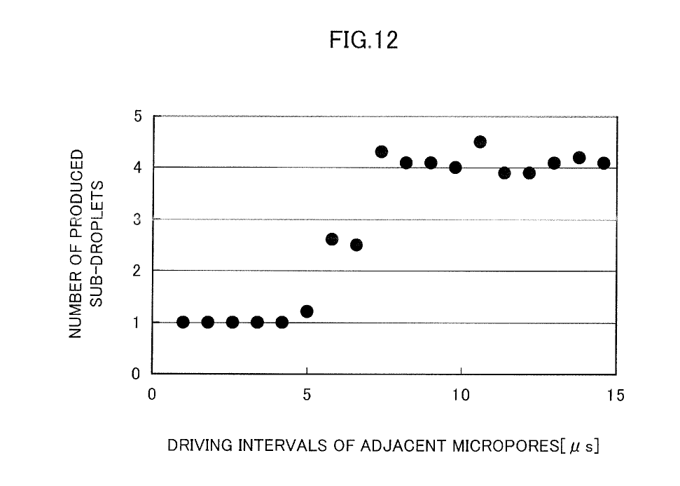

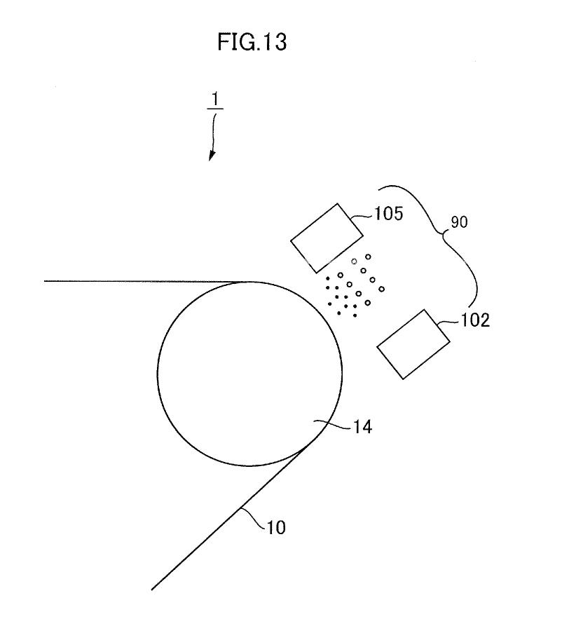

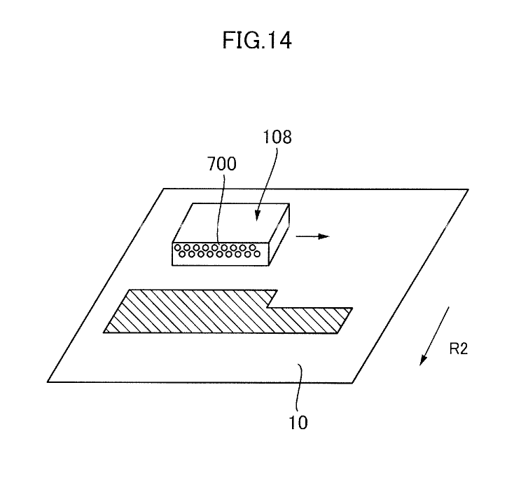

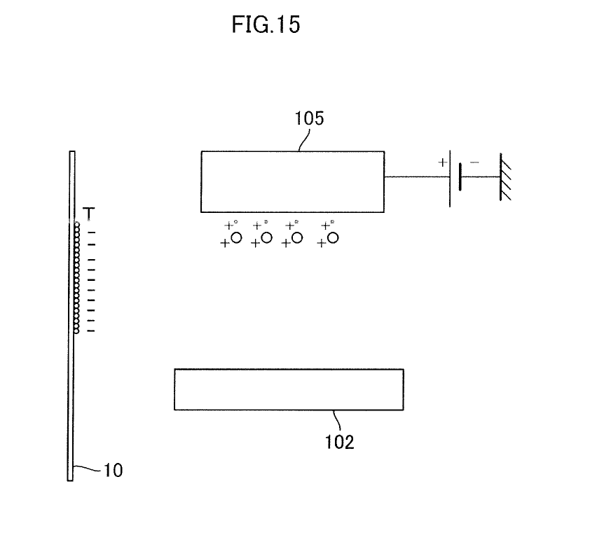

FIG. 12 is a graph explaining a relationship between driving intervals of adjacent micropores and a number of produced sub-droplets, FIG. 13 is a schematic diagram illustrating a disposition of the fixing solution supplying unit in a first modified example, FIG. 14 is a schematic diagram illustrating a move of the jet head in a second modified example, and FIG. 15 is a schematic diagram explaining electrification of the sub-droplet in a third modified example.

As shown in FIG. 12, in a case when the micropores of the jet head 105 communicate inside, a liquid level of the fixing solution moves up and down within the jet head 105 and a produced quantity of sub-droplets varies as the liquid droplet forming process changes in each micropore by changing time intervals of injection of the fixing solution from the neighboring micropores.

Due to that, the control portion 800 may also control the quantity of the fixing solution to be supplied by controlling the driving intervals of the adjacent micropores. The more the toner loading amount, the longer the control portion 800 may prolong the driving intervals of the adjacent micropores to increase the quantity of the fixing solution to be supplied. Meanwhile, if density of an image to be formed is low and a toner loading amount is less, the control portion 800 may shorten the driving intervals of the adjacent micropores to save a quantity of the fixing solution to be supplied. It is noted that the method for controlling the supplied quantity of the fixing solution is not limited to the examples explained with reference to FIGS. 11 and 12.

As shown in FIG. 4A, the fixing solution supplying unit 90 is disposed to face a plane part of the intermediate transfer belt 10 in the first embodiment. However, the disposition thereof is not limited to this position at all, and the fixing solution supplying unit 90 may be disposed at any place as long as the main droplets of the fixing solution do not impact the surface of the intermediate transfer belt 10.

Specifically, as shown in FIG. 13, the fixing solution supplying unit 90 is disposed at a curved portion of the intermediate transfer belt 10 supported by the drive roller 14 such that the main droplets do not impact the curved part of the intermediate transfer belt 10 in a first modified example.

As shown in FIG. 6, the stationary jet head 105 having a full length in the width direction of the intermediate transfer belt 10 is adopted in the first embodiment. In contrary to that, as shown in FIG. 14, a jet head 108 whose length in the width direction of the intermediate transfer belt 10 is short is reciprocated in the width direction of the intermediate transfer belt 10 to be able to supply the fixing solution to a whole range in the width direction of the intermediate transfer belt 10 in a second modified example. The jet head 108 is attached to a head scanning mechanism not shown as a head moving portion and is disposed to face the intermediate transfer belt 10. The head scanning mechanism reciprocates the jet head 108 such that the jet head 108 passes through a whole image area to which the toner image can be attached. Or, the jet head 108 is moved to a desirable position (where toner is attached) in the whole image area to supply the fixing solution.

As shown in FIG. 4A, the electric field applying unit 103 is provided to face the inner surface of the intermediate transfer belt 10 to form the electric field for moving the sub-droplets to the toner image in the first embodiment. However, the invention is not limited to the method of applying the electric field from the back surface of the intermediate transfer belt 10 by the electric field applying unit 103. For instance, according to a third modified example shown in FIG. 15, an electric field is effected directly between sub-droplets and non-fixed toner particles by applying voltage to the jet head 108 to apply electric charges of a polarity inverse from that of electric charges of the non-fixed toner particles to the sub-droplets. Although the main droplets are also electrified in this case, the main droplets are recovered by the main droplet recovering portion 102 without moving toward the non-fixed toner image because an electric charge amount per volume of the main droplet is small as compared to that of the sub-droplet and an apparent Coulomb force thereof is small.

Still further, although a non-contact type charging unit is used as the electric field applying unit 103 in the first embodiment, it is also possible to apply electric charges of a polarity opposite from the charging polarity of the sub-droplets from the back surface of the intermediate transfer belt 10 by using a contact type charging unit such as a charging brush.

Although the electric field is employed to move the sub-droplets of the fixing solution toward the toner image in the first embodiment, the sub-droplets of the fixing solution may be moved toward the toner image by sending air or using ultrasonic. In a case of moving sub-droplets of the fixing solution upward against the direction of the gravity as the fixing solution supplying surface faces downward in particular as shown in FIG. 4A, it is desirable to form an air flow that heads toward the surface of the intermediate transfer belt 10 by using a blowing unit. It is necessary to set strength of the air to be sent at that time to a level not flowing main droplets so much so that the main droplets can be recovered by the main droplet recovering portion 102.

### Second Embodiment

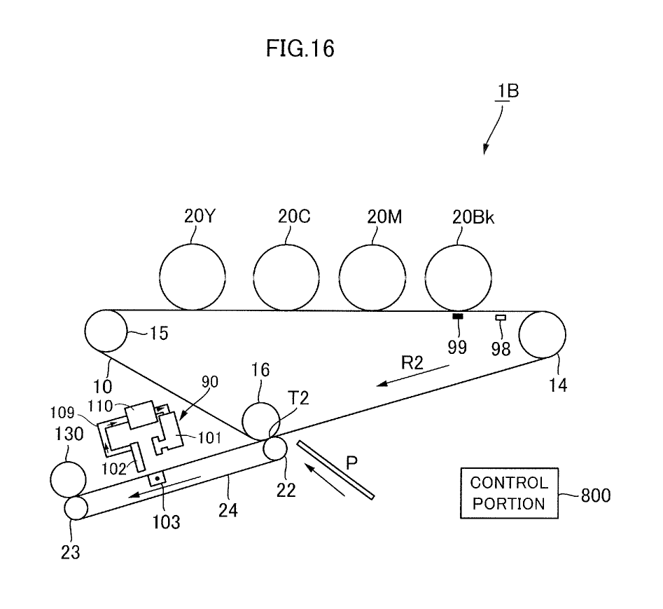

FIG. 16 is a schematic diagram illustrating a configuration of an image forming apparatus 1B of a second embodiment. As shown in FIG. 16, only disposition of the fixing solution supplying unit 90 and the electric field applying unit 103 of the image forming apparatus 1B of the second embodiment is different from that of the first embodiment shown in FIG. 4A, and the components of the image forming apparatus 1B including the fixing solution supplying unit 90 and the electric field applying unit 103 are the same with those of the first embodiment. Accordingly, the components in FIG. 16 common with or corresponding to those of the first embodiment will be denoted by the same reference numerals indicated in FIGS. 4 through 9 and an overlapped explanation will be omitted here.

The fixing solution supplying unit 90 of the second embodiment supplies sub-droplets of the fixing solution to a recording medium P to which a toner image has been transferred at a secondary transfer portion T2. That is, the fixing solution is supplied, not to the toner image before secondarily transferred to the recording medium P, but to the toner image that has been secondarily transferred to the recording medium P in the second embodiment.

The fixing solution supplying unit 90 injects the fixing solution 104 within a fixing solution reservoir out of the jet head 105 substantially in parallel in an advance direction of the recording medium P by receiving dot information from the control portion 800. Then, the fixing solution supplying unit 90 recovers main droplets among the injected liquid droplet particles by the main droplet recovering portion 102 and supplies sub-droplets to the non-fixed toner image by the electric field applying unit 103.

Then, the image forming apparatus 1B of the second embodiment applies pressure to the toner image to which the fixing solution has been supplied by a pressure roller 130. A surface of the pressure roller 130 is coated by fluororesin, e.g., PFA, so that the surface has water-repellent nature in order to accelerate permeation of the fixing solution 104 into the toner image. Because the pressure of the pressure roller 130 is applied for the purpose of enhancing the packing density of the toner particles as described above, it is not necessary to be so large and is around 0.1 MPa.

The image forming apparatus 1B of the second embodiment requires no special process to be implemented on the intermediate transfer belt 10 such as the water-repellent process implemented on the surface of the intermediate transfer belt 10 in the first embodiment. Due to that, the second embodiment is advantageous in that a material of the surface of the intermediate transfer belt 10 is not restricted and that only transfer characteristics can be pursued.

### Third Example

An image forming operation was executed by fabricating the fixing solution supplying unit 90 of the second embodiment as follows and by using the first fixing solution, i.e., the same fixing solution used in the first embodiment.

As shown in FIG. 5, the jet head 105 of the fixing solution supplying unit 90 is constructed in the same manner with that of the first example.

It was confirmed that the injection velocity of the main droplet 104a, the diameter of the main droplet 104a, the number of sub-droplets 104b generated together with one main droplet 104a, and the average diameter of the sub-droplet 104b are the same with those of the first example.

As shown in FIG. 16, a configuration of suctioning the fixing solution by the supply pump 110 from the main droplet recovering portion 102 through the fixing solution tube 109 and of returning the fixing solution to the fixing solution reservoir of the fixing solution injecting portion 101 was adopted. The other configuration is the same with that of the first example. Because the sub-droplets are supplied downward to the recording medium, the configuration related to the slit nozzle 116 and the fan 115 was omitted. A scorotron was used for the electric field applying unit 103. A surface layer of a silicon rubber elastic layer of the pressure roller 130 was coated by a fluororesin (PFA) tube.

It was confirmed that the fixing solution recovered by the main droplet recovering portion 102 can be favorably reused and that the sub-droplets negatively charged are led to the surface of the transfer belt (recording medium conveying belt) 24 when applied voltage of the scorotron was 8 kV in the same manner with the first example. It is noted the transfer belt 24 is carried the toner image through the recording medium and serving as the image carrier in this embodiment.

A fixed image having a favorable coloring property and an equally favorable fixability with the first example was obtained when the fixing solution supplying unit 90 was actuated to execute the image forming and fixing processes in accordance to the abovementioned sequence.

### Fourth Example

An image forming operation was executed by fabricating the fixing solution supplying unit 90 of the third example as follows and by using the second fixing solution, i.e., the same fixing solution used in the second example. As shown in FIG. 5, in the fourth example, the jet head 105 of the fixing solution supplying unit 90 is constructed in the same manner with that of the first example. As shown in FIG. 16, a disposition of The jet head 105 and a distance from the recording medium P are the same with those of the third example. In such a configuration, it was confirmed that the injection velocity of the main droplet 104a, the diameter of the main droplet 104a, the number of sub-droplets 104b generated together with one main droplet 104a, and the average diameter of the sub-droplet 104b are substantially the same with those of the second example.

As shown in FIG. 16, the configuration of suctioning the fixing solution by the supply pump 110 from the main droplet recovering portion 102 through the fixing solution tube 109 and of returning the fixing solution to the fixing solution reservoir of the fixing solution injecting portion 101 was adopted. The other configuration was the same with that of the first example. Because the sub-droplets are supplied downward to the recording medium, the configuration related to the slit nozzle 116 and the fan 115 was omitted. The scorotron was used for the electric field applying unit 103. The surface layer of the silicon rubber elastic layer of the pressure roller 130 was coated by a fluororesin (PFA) tube.

It was confirmed that the fixing solution recovered by the main droplet recovering portion 102 can be favorably reused and that the sub-droplets negatively charged are led to the surface of the recording medium conveying belt 24 when applied voltage of the scorotron was 6 kV in the same manner with the third example.

A fixed image having an equally favorable coloring property with the second example and favorable fixability and scratch resistance was obtained when the fixing solution supplying unit 90 was actuated to execute the image forming and fixing processes in accordance to the abovementioned sequence.

It is noted that the present invention can be carried out by another embodiment in which a part or whole of configuration thereof is replaced with a substitutional configuration as long as sub-droplets of a fixing solution from which main droplets are separated are supplied to a toner image.

Accordingly, the invention can be carried out regardlessly in one drum type or a tandem type, or an intermediate transfer type or a recording medium conveyer type image forming apparatus as long as the image forming apparatus is configured to supply a fixing solution to a toner image. The invention can be also carried out regardless to a number of image carriers, a method for charging the image carrier, a method for forming an electrostatic image, a developer and a developing method, a transfer method, and the like.

Still further, although the main part regarding the toner image formation/transfer operation has been explained in the embodiments described above, the invention can be carried out in image forming apparatuses of various uses such as a printer, various printing machines, a copier, a facsimile, a multi-function printer, and the like by adding necessary units, attachments, and a casing structure.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-008981, filed on Jan. 22, 2013, which is hereby incorporated by reference herein in its entirety.

What is claimed is:

1. An image forming apparatus, comprising:
a toner image forming portion configured to form a toner image;
an image carrier configured to carry the toner image formed by the toner image forming portion;
a fixing solution injecting portion disposed in proximity with the image carrier and configured to have micropores to inject a fixing solution, containing a water-soluble polymer and water, pulsewise for filling up gaps between toner particles and fixing the toner image, the fixing solution injecting portion producing sub-droplets of the fixing solution whose size is smaller than that of main droplets in producing the main droplets by injecting the fixing solution out of the micropores; and
a sub-droplet supplying portion configured to supply the sub-droplets to the toner image on the image carrier by separating the main droplets from the fixing solution injected out of the micropores.

2. The image forming apparatus according to claim 1, wherein the sub-droplet supplying portion includes a recovery member disposed to face the fixing solution injecting portion and receiving and recovering at least the main droplets injected out of the fixing solution injecting portion.

3. The image forming apparatus according to claim 2, wherein the fixing solution injecting portion is disposed such that the image carrier is not positioned on an injection orbit of the main droplets.

4. The image forming apparatus according to claim 2, wherein the recovery member is spaced away from the fixing solution injection portion by a distance that enables the main and sub-droplets to be separated from each other in accordance to a difference of reaching distances of the main and sub-droplets injected out of the fixing solution injecting portion.

5. The image forming apparatus according to claim 3, wherein the recovery member is spaced away from the fixing solution injection portion by a distance that enables the main and sub-droplets to be separated from each other in accordance to a difference of reaching distances of the main and sub-droplets injected out of the fixing solution injecting portion.

6. The image forming apparatus according to claim 2, wherein the sub-droplet supplying portion includes a guide portion configured to move the sub-droplets injected to a space between the fixing solution injecting portion and the recovery member toward the image carrier.

7. The image forming apparatus according to claim 5, wherein the sub-droplet supplying portion includes a guide portion configured to move the sub-droplets injected to a space between the fixing solution injecting portion and the recovery member toward the image carrier.

8. The image forming apparatus according to claim 6, wherein the guide portion includes an electric field forming portion configured to form an electric field between the space between the fixing solution injecting portion and the recovery member and the image carrier to electrically bias the sub-droplets injected to the space toward the image carrier.

9. The image forming apparatus according to claim 7, wherein the guide portion includes an airflow forming portion configured to form airflow between the space between the fixing solution injecting portion and the recovery member and the image carrier to blow the sub-droplets discharged to the space toward the image carrier.

10. The image forming apparatus according to claim 8, wherein the guide portion includes an airflow forming portion configured to form airflow between the space between the fixing solution injecting portion and the recovery member and the image carrier to blow the sub-droplets discharged to the space toward the image carrier.

11. The image forming apparatus according to claim 2, wherein the sub-droplet supplying portion includes a recycle portion configured to recycle at least the fixing solution of the main droplets recovered by the recovery member to the fixing solution injecting portion.

12. The image forming apparatus according to claim 6, wherein the sub-droplet supplying portion includes a recycle portion configured to recycle at least the fixing solution of the main droplets recovered by the recovery member to the fixing solution injecting portion.

13. The image forming apparatus according to claim 2, wherein the sub-droplet supplying portion separates also sub-droplets whose diameter is larger than that of toner particles forming the toner image from the fixing solution injected out of the fixing solution injecting portion and supplies sub-droplets whose diameter is smaller than that of the toner particles forming the toner image to the toner image on the image carrier.

14. The image forming apparatus according to claim 1, wherein the water-soluble polymer is a urethane resin.

15. The image forming apparatus according to claim 1, wherein an amount of water contained in the fixing solution and supplied per unit area is less than 15 g/m².

16. The image forming apparatus according to claim 10, wherein the water-soluble polymer is a urethane resin and an amount of water contained in the fixing solution and supplied per unit area is less than 15 g/m².

17. The image forming apparatus according to claim 1, further comprising a pressure portion configured to press a toner image on the image carrier to which the fixing solution of the sub-droplets has been supplied by the sub-droplet supplying portion with temperature and pressure that will not crush the toner particles.

18. A sub-droplet supplying unit, comprising:
a fixing solution injecting portion configured to inject a fixing solution pulsewise out of micropores to produce sub-droplets of the fixing solution smaller than main droplets of the fixing solution in producing the main droplets;
a recovery member disposed to face the fixing solution injecting portion and receiving and recovering at least the main droplets injected out of the fixing solution injecting portion; and
a recycling portion configured to collect at least the fixing solution of the main droplets recovered by the recovery member and to recycle to the fixing solution injecting portion;
whereby the sub-droplet supplying unit outputs the sub-droplets of the fixing solution injected out of the fixing solution injecting portion to outside.

19. An image forming method, comprising steps of:
transferring a toner image to an intermediate transfer body;
supplying liquid droplet particles of a fixing solution containing a water-soluble polymer of a urethane resin and water to the toner image on the intermediate transfer body; and
transferring the toner image on the intermediate transfer body to which the liquid droplet particles of the fixing solution have been supplied to a recording medium with pressure.

20. An image forming method, comprising steps of:
transferring a toner image to a recording medium;
supplying liquid droplet particles of a fixing solution containing a water-soluble polymer of a urethane resin and water to the toner image on the recording medium; and
pressing the toner image on the recording medium to which the liquid droplet particles of the fixing solution have been supplied to the recording medium.
